(19) United States
(12) Patent Application Publication
(10) Pub. No.: US 2008/0315167 A1
(43) Pub. Date: Dec. 25, 2008

(54) Engagement chain type hoisting and lowering device

(75) Inventors: Yoshifumi Takeuchi, Osaka (JP); Naoto Shibata, Osaka (JP); Toru Wada, Osaka (JP); Tomoyuki Saji, Osaka (JP)

Correspondence Address: William P. Oberhardt, LLC, Suite 2100, 70 W. Madison, Chicago, IL, 60602, US

(73) Assignee: Tsubakimoto Chain Co.

(21) Appl. No.: 12/214,278

(22) Filed: Jun. 18, 2008

(30) Foreign Application Priority Data
Jun. 21, 2007 (JP) 2007-163785

(51) Int. Cl. B66D 3/16

(52) U.S. Cl. 254/358

(57) ABSTRACT

An engagement chain type hoisting and lowering device is disclosed, including a hoisting and lowering table attached to the upper end of hoisting and lowering driving engagement chains. The engagement chains are raised and lowered by a pair of hoisting and lowering sprockets driven by a driving motor. The driving motor is located in a peripheral area spaced apart from the lowest lowered position of the hoisting and lowering table. In so doing, the lowest position of the hoisting and lowering table is lowered, reducing the burden of loading and unloading items onto the hoisting and lowering table, and making maintenance safe and simple.

### BACKGROUND OF THE INVENTION

1. Field of the Invention

The present invention relates to a hoisting and lowering device, which hoists and lowers a hoisting and lowering table in parallel with a set surface for use by production facilities in various kinds of production fields, a transfer facility, a care facility in a medical welfare field, a stage facility in an art field and the like, and more specifically relates to an engagement chain type hoisting and lowering device in which an engagement chain is adopted as a driving medium for hoisting and lowering operations.

2. Brief Description of the Related Art

In the field of hoisting and lowering devices for heavy articles and the like, there is a hoisting and lowering device, which is formed such that a plurality of cross links, which hoist and lower a hoisting and lowering pedestal while holding parallelism with a fixed base pedestal, are driven up and down by an electric motor type ball screw mechanism (see Japanese Laid-Open Patent Publication No. 11-193199, particularly page 1 and FIG. 1).

Further, there is a hoisting and lowering device, which hoists and lowers or pushes up articles by use of an engagement chain, which is integrally hoisted and lowered while being engaged with each other, also called a chuck chain (see Japanese Laid-Open Patent Publication No. 11-278797, particularly page 1 and FIG. 1).

However, since the former hoisting and lowering device using an electric motor type ball screw mechanism incorporates the electric motor type ball screw mechanism so that a plurality of cross links are driven up and down, there is a problem in hoisting and lowering movements in that hoisting and lowering movements of a hoisting and lowering pedestal cannot be attained at the same speed and rapidly in relation to the undulation angle of the cross links. Further, since the electric motor type ball screw mechanism is disposed in a position just under the hoisting and lowering pedestal, there is a problem in the utilization of the hoisting and lowering device in that a lowered position of the hoisting and lowering pedestal cannot be lowered below the height of the electric motor type ball screw mechanism, that is, the floor of the hoisting and lowering pedestal cannot be lowered, so that an enormous operational burden is required for loading and unloading of articles to be hoisted onto and lowered from the hoisting and lowering pedestal. And there is a troublesome problem in maintenance in that the hoisting and lowering pedestal becomes an obstacle during a maintenance operation of the electric motor type ball screw mechanism and the like so that the operability is damaged, and additionally there is a risk of an operator being compressed between the hoisting and lowering pedestal.

Further, since in the latter hoisting and lowering device using the engagement chain, a deflection guide portion of the chain guide includes a pair of vertical guide surfaces, which guide a roller of an engagement chain and a vertical wall-shaped accommodating guide portion is disposed in the vicinity of a pair of sprockets, there is a problem in utilization in that a lowered position of a load supporting member cannot be lowered below the heights of the pair of vertical guide surfaces and the accommodating guide portion, that is, the floor of the load supporting member cannot be lowered, so that an enormous operational burden is required in loading and unloading of articles to be hoisted onto and lowered from the load supporting member.

### BRIEF SUMMARY OF THE INVENTION

Accordingly, technical problems to be solved by the present invention, that is, the object of the present invention, is to provide an engagement chain type hoisting and lowering device in which the lowest lowered position of a hoisting and lowering table is lowered, loading and unloading operations of articles to be hoisted onto and lowered from a hoisting and lowering table are significantly reduced, the maintenance of a hoisting and lowering mechanism is safe and simple, and hoisting and lowering operations of the hoisting and lowering table can be attained at the same speed and rapidly.

The present invention solves the above-described problems by an engagement chain type hoisting and lowering device comprising a pair of hoisting and lowering sprockets, which rotate positively and reversely in opposite directions while facing each other in the same plane about a pair of rotation shafts arranged in parallel with a set surface, a pair of hoisting and lowering driving engagement chains, which engage with each other just after deflection driving from a horizontal direction to a vertical direction by said pair of hoisting and lowering sprockets to rise integrally in an engaged state and also disengage with each other to be branched from a vertical direction to a horizontal direction by said pair of hoisting and lowering sprockets during deflection driving, a hoisting and lowering table securely attached to an upper end of said hoisting and lowering driving engagement chain, which table is integrally hoisted and lowered, and a driving motor, which drives said pair of hoisting and lowering sprockets, characterized in that said driving motor is disposed in a peripheral area spaced apart from the lowest lowered position of said hoisting and lowering table.

The present invention further solves the above-described problems in that in addition to the engagement chain type hoisting and lowering device described herein, an engagement chain accommodating means, which accommodates said pair of hoisting and lowering driving engagement chains while branched in a horizontal direction, is disposed in a peripheral area spaced apart from the lowest lowered position of said hoisting and lowering table.

The present invention further solves the above-described problems in that in addition to the engagement chain type hoisting and lowering device described herein, a chain guide plate, which guides a pair of hoisting and lowering driving engagement chains, which are disengaged from said pair of hoisting and lowering sprockets, is provided in a region between the pair of opposed hoisting and lowering sprockets.

Since the engagement chain type hoisting and lowering device according to the present invention comprises a pair of hoisting and lowering sprockets, which rotate positively and reversely in opposite directions while facing each other in the same plane about a pair of rotation shafts arranged in parallel with a set surface, a pair of hoisting and lowering driving engagement chains, which engage with each other just after deflection driving from a horizontal direction to a vertical direction by said pair of hoisting and lowering sprockets to rise integrally in an engaged state and also disengage with each other to be branched from a vertical direction to a horizontal direction by said pair of hoisting and lowering sprockets during deflection driving, a hoisting and lowering table securely attached to an upper end of said hoisting and lowering driving engagement chain, which table is integrally hoisted and lowered, and a driving motor, which drives said pair of hoisting and lowering sprockets, the hoisting and lowering table can be hoisted and lowered in accordance with positive and reverse rotations of hoisting and lowering sprockets irrespective of the hoisting and lowering positions. Thus, hoisting and lowering operations of the hoisting and lowering table can be rapidly attained at the same speed and high design flexibility of the chain accommodating means and the driving portions can be realized. Additionally, significant benefits corresponding to the following peculiar configurations can be attained.

That is, since in the engagement chain type hoisting and lowering device of the present invention, the driving motor is disposed in a peripheral area spaced apart from the lowest lowered position of said hoisting and lowering table, lowering of the lowest lowered position of the hoisting and lowering table, that is, a low floor of the hoisting and lowering table, becomes possible irrespective of the size or height of this driving motor. Therefore, an operational burden of loading and unloading of articles to be hoisted onto and lowered from the hoisting and lowering table can be significantly reduced, and at the same time the driving motor does not become an obstruction during maintenance of a hoisting and lowering mechanism so that a safe and simple maintenance operation can be attained.

Further, according to the engagement chain type hoisting and lowering device of the present invention, since in the engagement chain type hoisting and lowering device described herein, an engagement chain accommodating means, which accommodates said pair of hoisting and lowering driving engagement chains while branched in a horizontal direction, is disposed in a peripheral area spaced apart from the lowest lowered position of said hoisting and lowering table, in addition to the benefits obtained by the engagement chain type hoisting and lowering device previous described herein, the lowest lowered position of the hoisting and lowering table can be lowered irrespective of the size or height of an accommodating space due to hoisting of a conventional hoisting and lowering driving engagement chain. That is, since the floor of the hoisting and lowering table can be lowered, an operational burden of loading and unloading of articles to be hoisted onto and lowered from the hoisting and lowering table can be significantly reduced and at the same time the maintenance of the hoisting and lowering driving engagement chain can be easily attained.

Further, according to the engagement chain type hoisting and lowering device of the present invention, since in the engagement chain type hoisting and lowering device described herein, a chain guide plate, which guides a pair of hoisting and lowering driving engagement chains, which are disengaged from the pair of hoisting and lowering sprockets, is provided in a region between the pair of opposed hoisting and lowering sprockets, in addition to the benefits obtained by the engagement chain type hoisting and lowering device previously described herein, the chain guide plate hoists a pair of hoisting and lowering driving engagement chains by being engaged with each other in an engaged state just after deflection driving from a horizontal direction to the vertical direction. Therefore, since a high vertical guide surface provided in a deflection guide portion of a chain guide in a hoisting and lowering device using a conventional engagement chain is not needed, a lower floor of the hoisting and lowering table can be realized.

### BRIEF DESCRIPTION OF THE DRAWINGS

FIG. 1 is a perspective view of a first embodiment of the engagement chain type hoisting and lowering device embodiment of the present invention.

FIG. 2 is a perspective view of a state where a hoisting and lowering table and a pantograph arm are removed from the embodiment shown in FIG. 1.

FIG. 3 is a partially enlarged view of a portion of the invention in the vicinity of a hoisting and lowering driving sprocket shown in FIG. 2.

FIG. 4 is a partially disassembled view showing a hoisting and lowering driving engagement chain used in FIG. 1.

FIG. 5 is a side view showing the most upper hoisted position of the engagement chain type hoisting and lowering device of the embodiment of the invention shown in FIG. 1.

FIG. 6 is an entire perspective view showing the lowest lowered position of the engagement chain type hoisting and lowering device of the embodiment of the invention shown in FIG. 1.

FIG. 7 is a side view of the embodiment of the invention shown in FIG. 1, showing the lowest lowered position of the engagement chain type hoisting and lowering device.

FIG. 8 is a perspective view of a second embodiment of the invention showing the lowest lowered position of an engagement chain type hoisting and lowering device.

### DETAILED DESCRIPTION OF THE INVENTION

If an engagement chain type hoisting and lowering device comprises a pair of hoisting and lowering sprockets, which rotate positively and reversely in opposite directions while facing each other in the same plane about a pair of rotation shafts arranged in parallel with a set surface, a pair of hoisting and lowering driving engagement chains, which engage with each other just after deflection driving from a horizontal direction to a vertical direction by the pair of hoisting and lowering sprockets to rise integrally in an engaged state and also disengage with each other to be branched from a vertical direction to a horizontal direction by the pair of hoisting and lowering sprockets during deflection driving, a hoisting and lowering table securely attached to an upper end of the hoisting and lowering driving engagement chain, which table is integrally hoisted and lowered, and a driving motor, which drives the pair of hoisting and lowering sprockets, and the driving motor is disposed in a peripheral area spaced apart from the lowest lowered position of the hoisting and lowering table so that the lowest lowered position of the hoisting and lowering table is lowered, loading and unloading operations of articles to be hoisted onto and lowered from the hoisting and lowering table are significantly reduced, the maintenance of a hoisting and lowering mechanism is safe and simple, and hoisting and lowering operations of the hoisting and lowering table can be attained at the same speed and rapidly, any particular embodiments of the engagement chain type hoisting and lowering device of the present invention may be adopted.

For example, in the engagement chain type hoisting and lowering device of the present invention, even if a set surface is a floor surface on which the device is installed, or even if the set surface is a ceiling surface from which the device is hung, there is no problem in hoisting and lowering operations. And if the set surface is a lateral wall surface, which is a cantilever supporting form, there is no problem in advancing and retracting operations, which correspond to hoisting and lowering operations.

Further, the hoisting and lowering driving engagement chain, used in the engagement chain type hoisting and lowering device of the present invention is a so-called chuck chain. And if the hoisting and lowering driving engagement chains are engaged with each other just after deflection driving by a pair of hoisting and lowering sprockets from a horizontal direction to a vertical direction to integrally rise in an engaged state and they are also disengaged from each other by the pair of pair of hoisting and lowering sprockets from a vertical direction to a horizontal direction to be branched, any particular chain embodiments may be adopted. For example, any engagement chains such as a chain having a roller, a chain having a bush, a chain of a single row of chain links in the chain width direction, a chain having a plurality of rows of chain links in the chain width direction, or a chain of their combination may be adopted.

Further, according to the engagement chain type hoisting and lowering device of the present invention, a hoisting and lowering table, which hoists and lowers articles to be hoisted and lowered, is hoisted and lowered by driving force of the hoisting and lowering driving engagement chain. However, to ensure stable hoisting and lowering operations of this hoisting and lowering table, a hoisting and lowering auxiliary guide means is preferably intervened between a hoisting and lowering table and a set surface side. Particular forms of the hoisting and lowering auxiliary guide means may be an X-shaped pantograph arm, which is used in a scissor lifter, and a telescope pipe, which is used in a guide post lifter and the like.

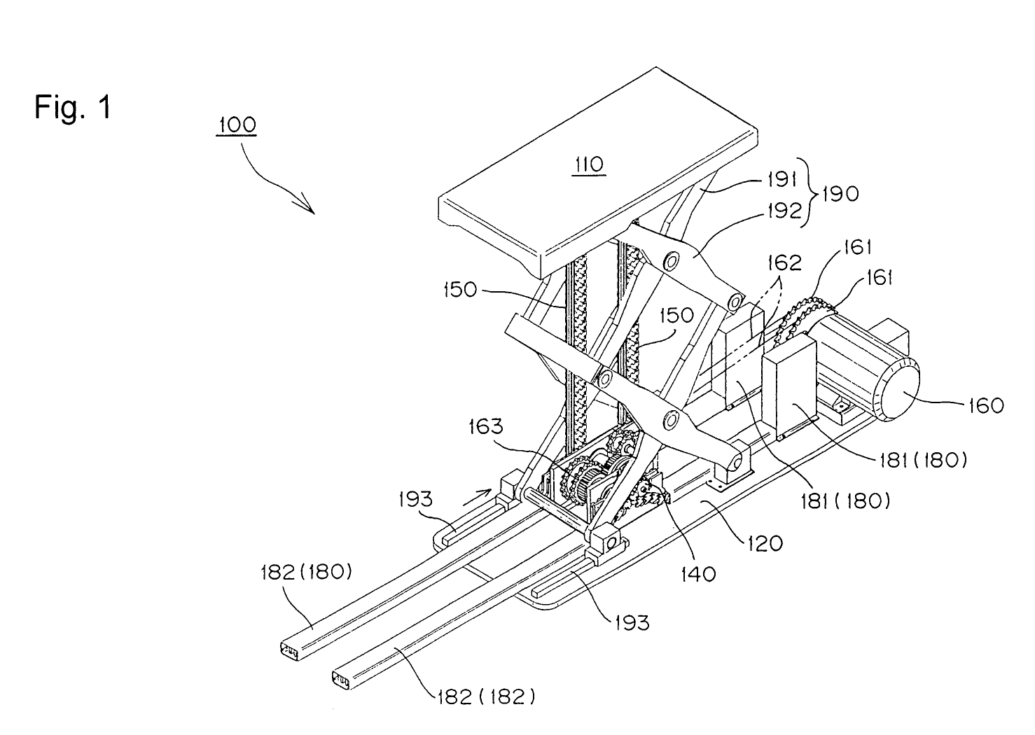

Embodiments of the present invention will be described with reference to FIGS. 1 to 8.

First, an engagement chain type hoisting and lowering device 100, which is a first embodiment of the present invention, is set in an installed state on a working floor for hoisting and lowering a hoisting and lowering table 110 on which heavy articles (not shown) are loaded in parallel with a set surface as shown in FIG. 1.

In the engagement chain type hoisting and lowering device 100, which is the first embodiment of the present invention, comprises, as shown in FIGS. 1 to 4, a base plate 120 mounted on a set surface where the above-described hoisting and lowering table 110 is hoisted and lowered in parallel with each other, a pair of hoisting and lowering sprockets 140, 140, which rotate positively and reversely in opposite directions while facing each other in the same plane about a pair of rotation shafts 130, 130 arranged in parallel with the base plate 120, a pair of hoisting and lowering driving engagement chains 150, 150, which are disengaged from these pair of hoisting and lowering sprockets 140, 140 to hoist and lower the hoisting and lowering tables 110, the above-described hoisting and lowering table 110 securely attached to an upper end of the hoisting and lowering driving engagement chains 150, 150, and a driving motor 160, which drives the pair of hoisting and lowering sprockets 140, 140, as basic device configurations.

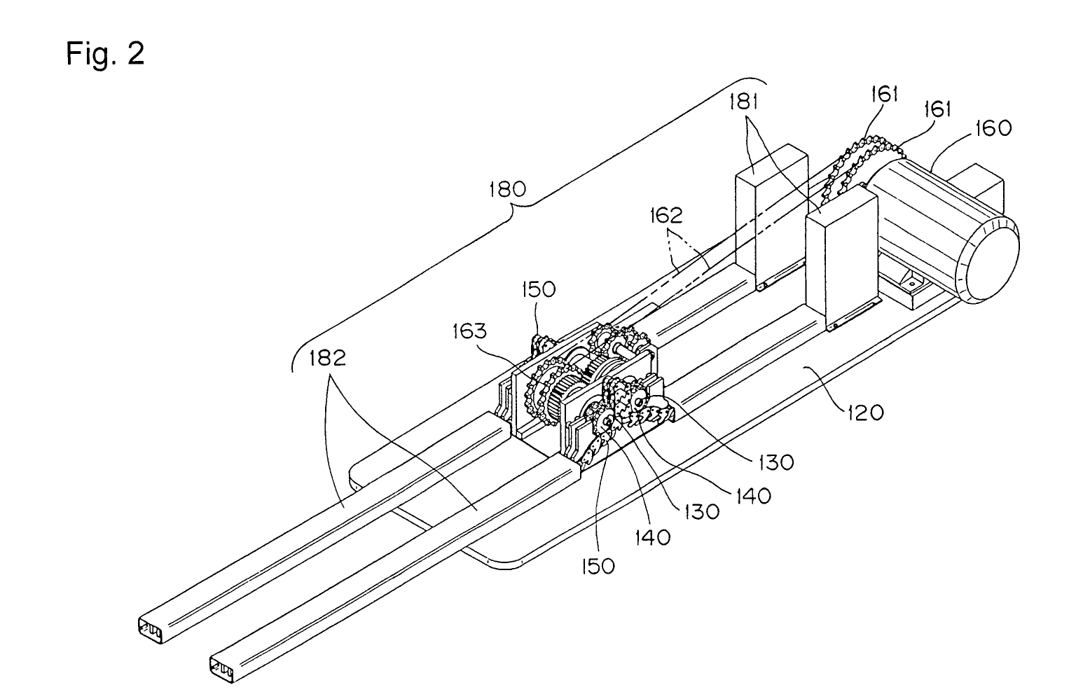

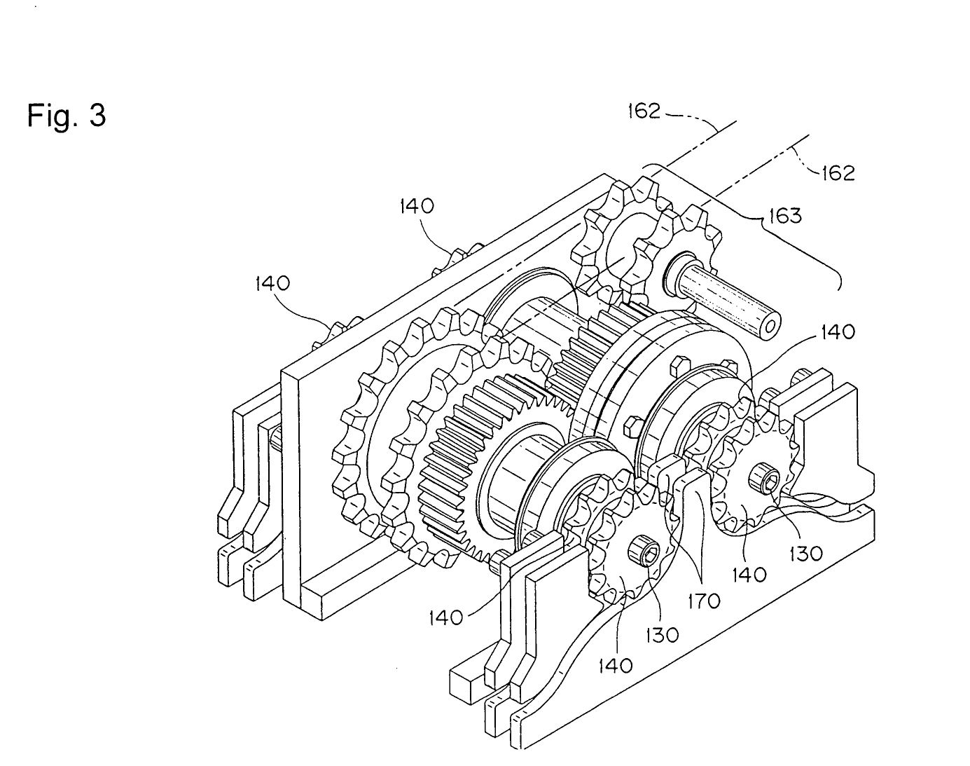

It is noted that the reference numerals 161, 161 shown in FIGS. 1 and 2, denote a pair of driving sprockets coaxially arranged on an output shaft side of the driving motor 160, the reference numerals 162, 162 denote a pair of power transmission chains composed of roller chains for transmitting power from the driving sprockets 161, 161 to a side of a pair of hoisting and lowering sprockets 140, 140, and the reference numerals 163, 163 shown in FIG. 3 denote a speed change gear group, which transmits power from the pair of power transmission chains 162, 162 to the pair of hoisting and lowering sprockets 140, 140 so that directional rotation is changed and positive and reverse rotations are performed in opposite directions to each other.

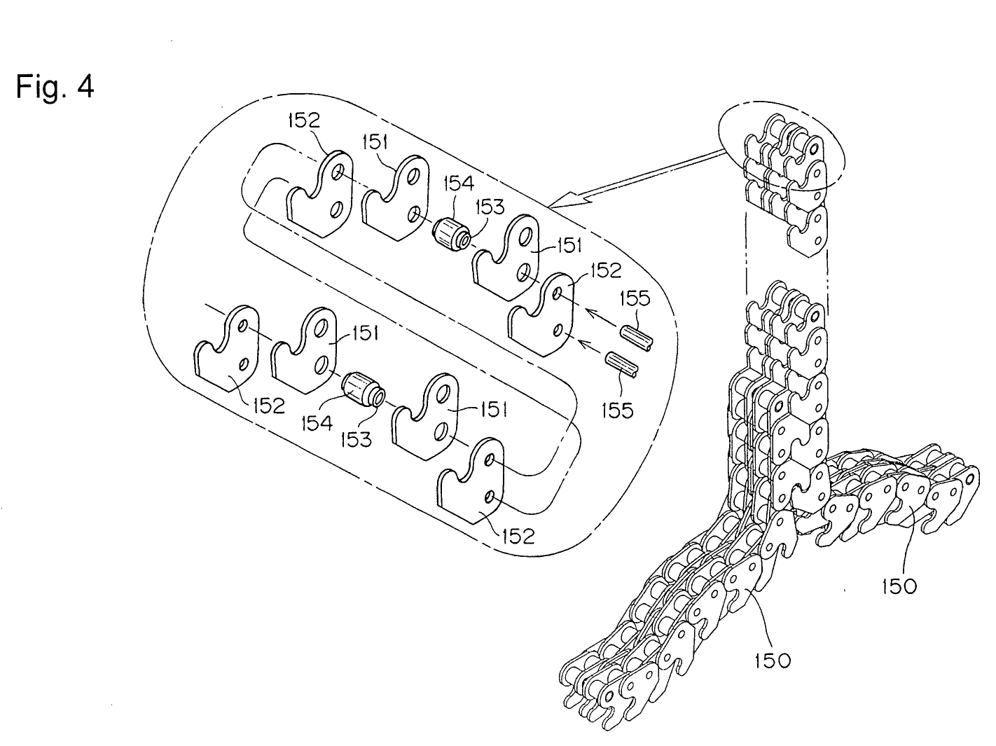

Further, a pair of hoisting and lowering driving engagement chains 150, 150, used in the engagement chain type hoisting and lowering device 100 of the first embodiment of the present invention, are so-called chuck chains, and are respectively composed, as shown in FIG. FIG. 4, in two rows of chain links in a chain width direction by use of a hook-shaped inner tooth plate 151, a hook-shaped outer tooth plate 152, which overlaps the inner tooth plate while shifted by a half pitch with respect to the inner tooth plate 151, a bush 153, which connects and fixes the inner tooth plates 151 in the chain width direction, a roller 154 fitted onto the bush and connecting pins, which connect and fix the outer tooth plates 152 in the chain width direction. Further, the pair of hoisting and lowering driving engagement chains 150, 150 are arranged so that they are engaged with each other just after deflection driving from the horizontal direction to the vertical direction by these pair of hoisting and lowering sprockets 140, 140 in an engaged state and they are also disengaged from each other during deflection driving by a pair of hoisting and lowering sprockets 140, 140 from the vertical direction to the horizontal direction to be branched.

In the engagement chain type hoisting and lowering device 100, which is the first embodiment of the present invention, a chain guide plate 170, which guides a pair of hoisting and lowering driving engagement chains 150, 150, which are disengaged from the pair of hoisting and lowering sprockets 140, 140, is provided in a region between the pair of opposed hoisting and lowering sprockets 140, 140, so that a pair of hoisting and lowering driving engagement chains 150, 150 are engaged with each other just after the deflection driving from a horizontal direction to a vertical direction to be integrally hoisted in an engaged state.

And one of a pair of hoisting and lowering driving engagement chains 150, 150 disengaged from each other and branched is accommodated in a chain accommodating means 180 composed of a winding type accommodating box 181 disposed on a driving motor 160 side and the other of the pair of hoisting and lowering driving engagement chains 150, 150 is accommodated in a chain accommodating means 180 composed of a linear accommodating rail 182 disposed at the opposite side to the driving motor 160.

Further, as shown in FIG. 1, the engagement chain type hoisting and lowering device 100 is formed so that stable hoisting and lowering operations of the hoisting and lowering table 110 are guided by intervening upper and lower two step connected hoisting and lowering auxiliary guide means 190 composed of an inner arm 191 and an outer arm 192, known as an X-shaped pantograph arm, between the hoisting and lowering table 110 and a set surface side base plate 120.

It is noted that the reference numeral 193 shown in FIG. 1 and the like denotes slide rails for sliding lower ends of the inner arms 191 in accordance with hoisting and lowering operations.

Here, the driving motor 160, which is the most characteristic in the engagement type chain hoisting and lowering device 100, which is the first embodiment of the present invention, is disposed in a peripheral area spaced apart from the lowest lowered position of the hoisting and lowering table 110, that is, in a portion other than a region under the projection of the hoisting and lowering table 110 as shown in FIG. 1 and the like. Further, the above-described chain accommodating means 180 is also disposed in a peripheral area spaced apart from the lowest lowered position of the hoisting and lowering table 110, that is, in a portion other than a region under the projection of the hoisting and lowering table 110 as well as the driving motor 160 as shown in FIG. 1.

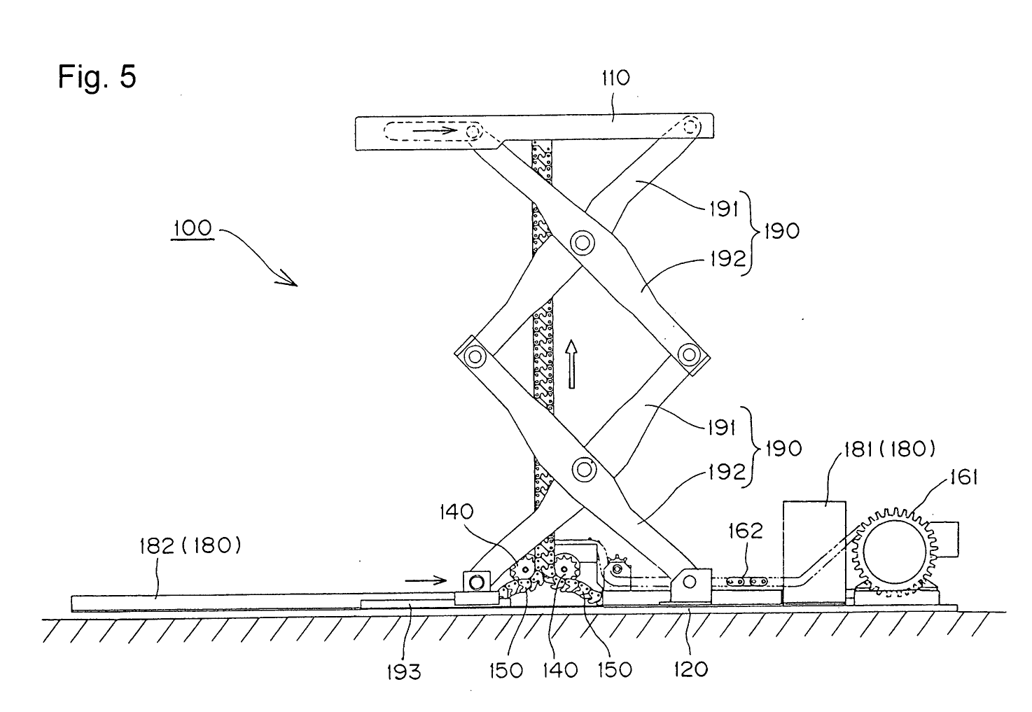

Next, hoisting and lowering operations of the engagement chain type hoisting and lowering device 100, which is the first embodiment of the present invention, will be explained based on FIG. 1 and FIGS. 5 to 7. First, as shown in FIG. 1 and FIG. 5, in a case where a hoisting and lowering table 110 reaches the most upper hoisted position, a pair of hoisting and lowering driving engagement chains 150, 150 are respectively sent out from a chain accommodating means 180 composed of a chain accommodating box 181 and a linear accommodating rail 182 by a pair of hoisting and lowering sprockets 140, 140, and the pair of hoisting and lowering driving engagement chains 150, 150 are rapidly hoisted at the same speed in accordance with an output of a driving motor 160 while supporting the entire weight of the hoisting and lowering table 110 carrying heavy articles (not shown). It is noted at this time that upper and lower two step connected form hoisting and lowering auxiliary guide means 190 composed of an inner arm 191 and an outer arm 192, the above-described X-shaped pantograph arm, guides a stable hoisting operation of the hoisting and lowering table 110.

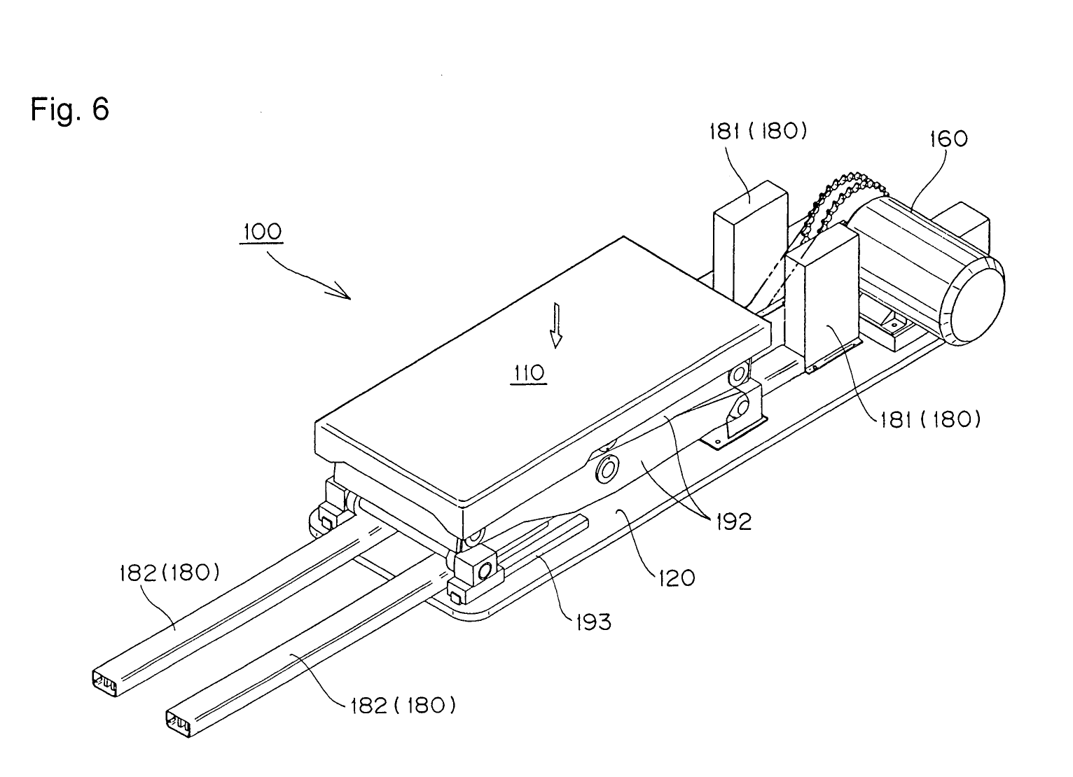

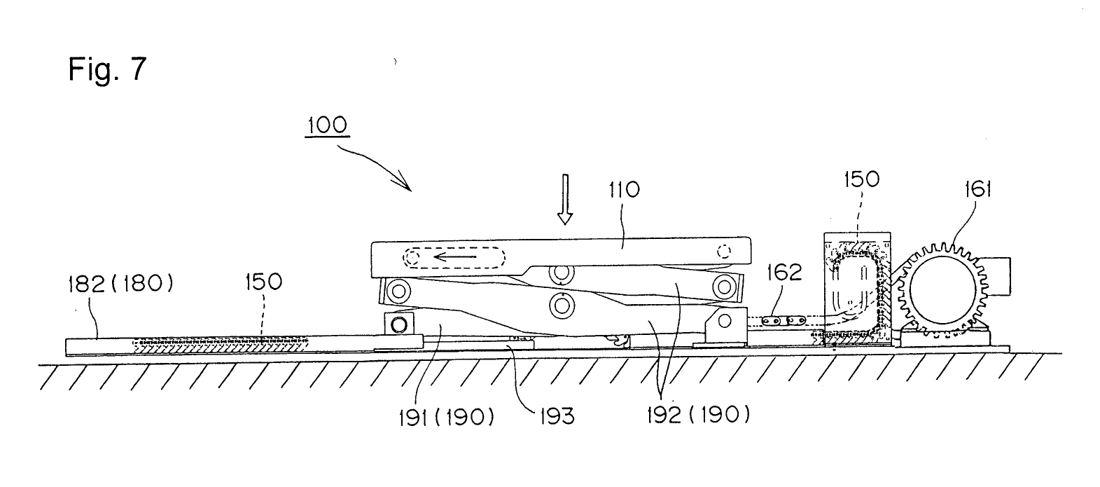

On the other hand, as shown in FIGS. 6 and 7, in a case where the hoisting and lowering table 110 reaches the lowest lowered position, a pair of hoisting and lowering driving engagement chains 150, 150 are respectively drawn into the chain accommodating means 180 composed of a chain accommodating box 181 and a linear accommodating rail 182 by a pair of hoisting and lowering sprockets 140, 140, while being branched, and the pair of hoisting and lowering driving engagement chains 150, 150 are rapidly lowered at the same speed in accordance with an output of a driving motor 160 while supporting the entire weight of the hoisting and lowering table 110 carrying articles to be hoisted and lowered (not shown) comprised of heavy articles. It is noted at this time that upper and lower two step connected form hoisting and lowering auxiliary guide means 190, composed of the above-described X-shaped an inner arm 191 and an outer arm 192, guides a stable lowering operation of the hoisting and lowering table 110 while being folded.

As described above, in the engagement chain type hoisting and lowering device 100, which is the first embodiment of the present invention, hoisting and lowering operations of the hoisting and lowering table 110 can be attained at the same speed and rapidly, and high design flexibility of driving parts containing the chain accommodating means 180 and the driving motor 160 can be realized, and the driving motor 160 and the engagement chain accommodating means 180 are disposed in a peripheral area spaced apart from the lowest lowered position of the hoisting and lowering table 110. Therefore, since the lowest lowered position of the hoisting and lowering table 110 can be lowered, that is, the floor of the hoisting and lowering table 110 can be lowered irrespective of the sizes or heights of the driving motor 160 and the chain accommodating means 180, an operational burden of loading and unloading of articles to be hoisted onto and lowered from the hoisting and lowering table 110 can be significantly reduced, and at the same time the driving motor 160 and the chain accommodating means 180 do not become obstructions during maintenance of a hoisting and lowering mechanism so that a safe and simple maintenance operation can be attained.

Further, since a chain guide plate 170, which guides a pair of hoisting and lowering driving engagement chains 150, 150, which are disengaged from the pair of hoisting and lowering sprockets 140, 140, is provided in a region between the pair of opposed hoisting and lowering sprockets 150, 150, a high vertical guide surface provided in a deflection guide portion of a chain guide in a conventional hoisting and lowering device using an engagement chain is not needed. A lower floor of the hoisting and lowering table can thereby be realized. Thus, the benefits of the first embodiment of the present invention are very large.

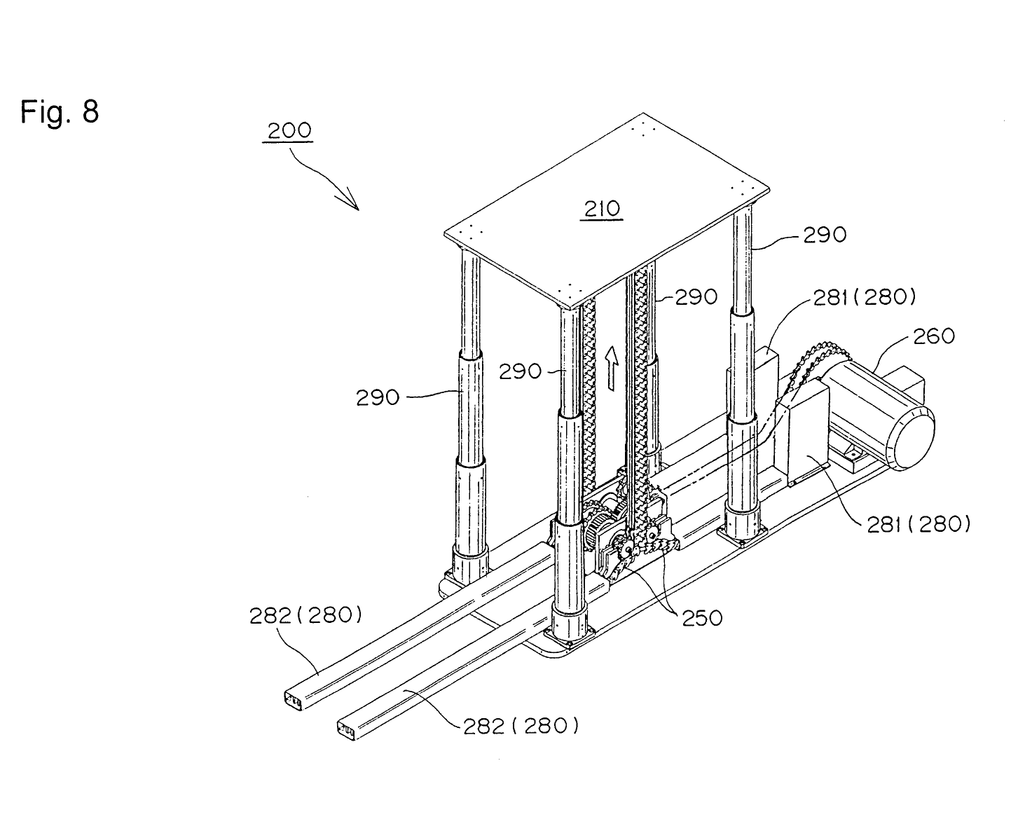

Next, FIG. 8 shows an engagement chain type hoisting and lowering device 200, which is a second embodiment of the present invention. Since the engagement chain type hoisting and lowering device 200, which is the second embodiment of the present invention, has just the same basic device configurations as those of the engagement chain type hoisting and lowering device 100, which is the above-described first embodiment, their explanations are omitted by changing the reference numerals of the 100s denoted to the same members to the 200s. Therefore, since in the engagement chain type hoisting and lowering device 200, which is the second embodiment of the present invention, only a hoisting and lowering auxiliary means 290 is different from the above-described engagement chain type hoisting and lowering device 100, which is the first embodiment of the present invention, only this hoisting and lowering auxiliary means 290 will be described below.

That is, according the engagement chain type hoisting and lowering device 200, which is the second embodiment of the present invention, a hoisting and lowering guide means 290 composed of telescopic pipes each diameter-reduced upward are intervened at four positions between a hoisting and lowering table 210 and a set surface side base plate 220 so that stable hoisting and lowering operations of the hoisting and lowering table 210 are guided.

As described above, in the engagement chain type hoisting and lowering device 200, which is the second embodiment of the present invention, hoisting and lowering operations of the hoisting and lowering table 210 can be attained at the same speed and rapidly, and high design flexibility of driving parts containing the chain accommodating means 280 and the driving motor 260 can be realized like the engagement chain type hoisting and lowering device 100, which is the first embodiment of the present invention, and the driving motor 260 and the engagement chain accommodating means 280 are disposed in a peripheral area spaced apart from the lowest lowered position of the hoisting and lowering table 210. Therefore, since the lowest lowered position of the hoisting and lowering table 210 can be lowered, that is, the floor of the hoisting and lowering table 210 can be lowered irrespective of sizes or heights of the driving motor 260 and the chain accommodating means 280, an operational burden of loading and unloading of articles to be hoisted onto and lowered from the hoisting and lowering table 210 can be significantly reduced, and at the same time the driving motor 260 and the chain accommodating means 280 do not become obstructions during maintenance of a hoisting and lowering mechanism so that a safe and simple maintenance operation can be attained. Thus, the benefits of the second embodiment of the present invention are very large.

We claim:

1-3. (canceled)

4. An engagement chain type hoisting and lowering device comprising a pair of hoisting and lowering sprockets, which rotate positively and reversely in opposite directions while facing each other in the same plane about a pair of rotation shafts arranged in parallel with a set surface, a pair of hoisting and lowering driving engagement chains, which engage with each other just after deflection driving from a horizontal direction to a vertical direction by said pair of hoisting and lowering sprockets to rise integrally in an engaged state and also disengage with each other to be branched from a vertical direction to a horizontal direction by said pair of hoisting and lowering sprockets during deflection driving, a hoisting and lowering table securely attached to an upper end of said hoisting and lowering driving engagement chains, which hoisting and lowering table is hoisted and lowered by said engaged pair hoisting and lowering engagement chains, and a driving motor, which drives said pair of hoisting and lowering sprockets, wherein the improvement comprises:
said driving motor being disposed in a peripheral area spaced apart from the lowest lowered position of said hoisting and lowering table.

5. An engagement chain type hoisting and lowering device according to claim 4, wherein the improvement further comprises:
an engagement chain accommodating means, which accommodates said pair of hoisting and lowering driving engagement chains while branched in a horizontal direction in the disengaged condition, said engagement chain accommodating means being disposed in a peripheral area spaced apart from the lowest lowered position of said hoisting and lowering table.

6. An engagement chain type hoisting and lowering device according to claim 4, wherein the improvement further comprises:
a chain guide plate, for guiding a pair of hoisting and lowering driving engagement chains, when said hoisting and lowering driving engagement chains are disengaged from said pair of hoisting and lowering sprockets, said chain guide plate being provided in a region between the pair of opposed hoisting and lowering sprockets.

7. An engagement chain type hoisting and lowering device according to claim 5, wherein the improvement further comprises:
a chain guide plate, for guiding a pair of hoisting and lowering driving engagement chains, when said hoisting and lowering driving engagement chains are disengaged from said pair of hoisting and lowering sprockets, said chain guide plate being provided in a region between the pair of opposed hoisting and lowering sprockets.
